(19) United States
(12) Patent Application Publication
(10) Pub. No.: US 2023/0417564 A1
(43) Pub. Date: Dec. 28, 2023

(54) FLEET MANAGEMENT SYSTEMS AND METHODS FOR PROVIDING OPTIMIZED CHARGING PATHS

(71) Applicant: FORD GLOBAL TECHNOLOGIES, LLC, Dearborn, MI (US)

(72) Inventors: Stuart C. SALTER, White Lake, MI (US); Sanjay DAYAL, Saratoga, CA (US); Pietro BUTTOLO, Dearborn Heights, MI (US); Ryan O'GORMAN, Beverly Hills, MI (US)

(21) Appl. No.: 17/849,813

(22) Filed: Jun. 27, 2022

(51) Int. Cl. G01C 21/34; G07C 5/10; B60L 53/66; G06Q 30/02; G06Q 10/00

(52) U.S. Cl. CPC G01C 21/3469; G07C 5/10; B60L 53/66; G01C 21/3446; G06Q 30/0278; G06Q 10/20; B60L 50/60

(57) ABSTRACT

Systems and methods are disclosed for providing optimized, multi-objective charge planning strategies for electrified vehicles of a vehicle fleet. The proposed systems and methods may utilize a multi-objective approach to charge planning. The multi-objective approach may account for factors such as time, wear, and cost to charge by assigning a cost value to each factor. The proposed systems and methods may further leverage charging at fleet owned/managed depots, public charging stations, and private, residential charging locations when solving the charging path optimization problem for each vehicle of the fleet.

### TECHNICAL FIELD

This disclosure relates generally to systems and methods for providing optimized, multi-objective charge planning strategies for each vehicle of an electrified vehicle fleet.

### BACKGROUND

Electrified vehicles differ from conventional motor vehicles because they are selectively driven by one or more traction battery pack powered electric machines. The electric machines can propel the electrified vehicles instead of, or in combination with, an internal combustion engine. Some electrified vehicles may be operated in the commercial context as part of a vehicle fleet.

### SUMMARY

A fleet management system according to an exemplary aspect of the present disclosure includes, among other things, a plurality of electrified vehicles, and a control module programmed to create an optimized charging path control strategy that includes instructions for when, where, and how long to charge each of the plurality of electrified vehicles prior to, during, or after a delivery/servicing task. The instructions are derived based on a multi-objective charging cost goal.

In a further non-limiting embodiment of the foregoing system, the multi-objective charging cost goal is based on a cost associated with a delivery time, a cost associated with a vehicle component wear, and a cost associated with charging.

In a further non-limiting embodiment of either of the foregoing systems, the control module is further programmed to modify the instructions according to a revised wait time at an assigned charging location.

In a further non-limiting embodiment of any of the foregoing systems, the control module is a component of at least one of the plurality of electrified vehicles.

In a further non-limiting embodiment of any of the foregoing systems, the control module is a component of a cloud-based server system.

In a further non-limiting embodiment of any of the foregoing systems, the cloud-based server system is operably connected to a charging station server. The multi-objective charging cost goal is derived using information from the charging station server.

In a further non-limiting embodiment of any of the foregoing systems, the multi-objective charging cost goal is further derived using vehicle information and driver information associated with each of the plurality of electrified vehicles.

In a further non-limiting embodiment of any of the foregoing systems, the multi-objective charging cost goal is further derived using trip planner information associated with each of the plurality of electrified vehicles.

In a further non-limiting embodiment of any of the foregoing systems, the optimized charging path control strategy includes instructions for charging at least one of the plurality of electrified vehicles a residential charging location.

In a further non-limiting embodiment of any of the foregoing systems, the control module is programmed to execute an optimization algorithm for preparing the optimized charging path control strategy.

An electrified vehicle according to another exemplary aspect of the present disclosure includes, among other things, a traction battery pack, and a control module programmed to receive an optimized charging path control strategy that includes instructions for when, where, and how long to charge the traction battery pack prior to, during, or after an assigned delivery/servicing task. The instructions are derived based on a multi-objective charging cost goal.

In a further non-limiting embodiment of the foregoing electrified vehicle, the multi-objective charging cost goal is based on a cost associated with a delivery time, a cost associated with a vehicle component wear, and a cost associated with recharging the traction battery pack.

In a further non-limiting embodiment of either of the foregoing electrified vehicles, the multi-objective charging cost goal is derived using information from a charging station server.

In a further non-limiting embodiment of any of the foregoing electrified vehicles, the multi-objective charging cost goal is further derived using vehicle information and driver information associated with the electrified vehicle.

In a further non-limiting embodiment of any of the foregoing electrified vehicles, the multi-objective charging cost goal is further derived using trip planner information associated with the electrified vehicle.

In a further non-limiting embodiment of any of the foregoing electrified vehicles, the optimized charging path control strategy includes instructions for charging the traction battery pack at a residential charging location.

In a further non-limiting embodiment of any of the foregoing electrified vehicles, the optimized charging path control strategy is received from a cloud-based server system.

In a further non-limiting embodiment of any of the foregoing electrified vehicles, the electrified vehicle is part of a vehicle fleet.

In a further non-limiting embodiment of any of the foregoing electrified vehicles, the electrified vehicle is a plug-in type electrified vehicle.

A charge planning method according to another exemplary aspect of the present disclosure includes, among other things, assigning a cost to time for performing a delivery/servicing task for each electrified vehicle of a vehicle fleet, assigning a cost to vehicle component wear for performing the delivery/service task for each electrified vehicle of the vehicle fleet, estimating a range constraint for each electrified vehicle of the vehicle fleet, and generating an optimized charging path control strategy for charging each electrified vehicle of the vehicle fleet. The optimized charging path control strategy is derived at least from assigning the cost to time, assigning the cost to vehicle component wear, and estimating the range constraint.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates a fleet management system for managing charge planning of a fleet of electrified vehicles.

FIG. 2 schematically illustrates a control system of an exemplary fleet management system.

FIG. 3 is a flow chart of an exemplary optimized charging path control strategy for optimizing charge planning of each electrified vehicle associated with a vehicle fleet.

### DETAILED DESCRIPTION

This disclosure relates to systems and methods for providing optimized, multi-objective charge planning strategies for electrified vehicles of a vehicle fleet. The proposed systems and methods may utilize a multi-objective approach to charge planning. The multi-objective approach may account for factors such as time, wear, and cost to charge by assigning a cost value to each factor. The proposed systems and methods may further leverage charging at fleet owned/managed depots, public charging stations, and private, residential charging locations when solving the charging path optimization problem for each vehicle of the fleet. These and other features of this disclosure are discussed in greater detail in the following paragraphs of this detailed description.

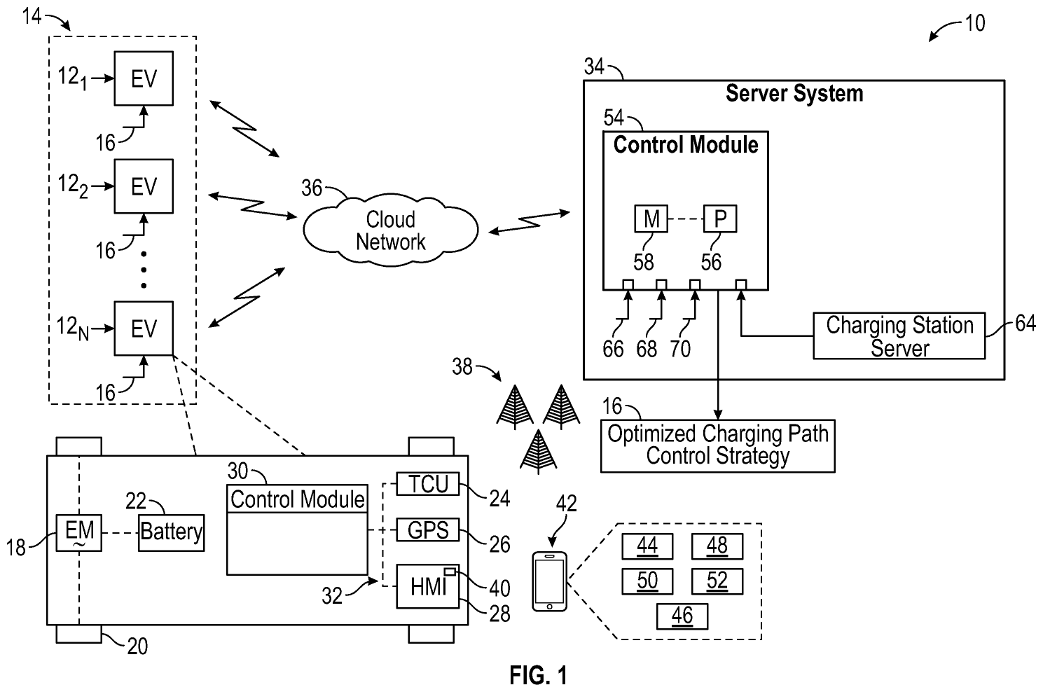

FIG. 1 schematically illustrates a fleet management system 10 (hereinafter “the system 10”) for performing optimized charge planning tasks associated with a vehicle fleet 14 of electrified vehicles 12. Among other functions, the system 10 may be configured for generating an optimized charging path control strategy 16 for each electrified vehicle 12 of the vehicle fleet 14. The optimized charging path control strategy 16 may be designed to provide delivery efficiency and quality (e.g., of goods and/or services) while minimizing recharging and maintenance costs. The optimized charging path control strategy 16 may be derived based at least in part on various cost-related parameters, including but not limited to estimated costs associated with time, wear on vehicle components, and charging. The cost-related parameters may be balanced to create a charging cost goal for each electrified vehicle 12 of the vehicle fleet 14. Rather than optimizing a topological route such as in prior fleet management systems, the system 10 may provide for the continuous and iterative optimization of each charging cost goal in order to determine where, when, and how much to charge each electrified vehicle 12 of the vehicle fleet 14.

The vehicle fleet 14 may include a plurality of electrified vehicles 12₁-12_{N}, where “N” represents any number. The total number of electrified vehicles 12 associated with the vehicle fleet 14 is not intended to limit this disclosure. Unless stated otherwise herein, reference numeral “12” refers to any of the electrified vehicles when used without any alphabetic identifier immediately following the reference numeral.

The electrified vehicles 12 are schematically illustrated in FIG. 1, and each such vehicle could embody any type of vehicle configuration, such as car, a truck, a van, a sport utility vehicle (SUV), etc. In an embodiment, each electrified vehicle 12 is a plug-in type electrified vehicle (e.g., a plug-in hybrid electric vehicle (PHEV) or a battery electric vehicle (BEV)) or a fuel cell vehicle. In some implementations, one or more of the electrified vehicles 12 of the vehicle fleet 14 could be configured as an autonomous vehicle (i.e., a driverless vehicle).

Although a specific component relationship is illustrated in the figures of this disclosure, the illustrations are not intended to limit this disclosure. The placement and orientation of the various components of the depicted electrified vehicles are shown schematically and could vary within the scope of this disclosure.

In addition, the various figures accompanying this disclosure are not necessarily drawn to scale, and some features may be exaggerated or minimized to emphasize certain details of a particular component or system.

As schematically depicted, each electrified vehicle 12 may include an electrified powertrain capable of applying a torque from one or more electric machines 18 (e.g., electric motors) for driving one or more drive wheels 20. Each electrified vehicle 12 may further include a traction battery pack 22 for powering the electric machine 18 and other electrical loads of the electrified vehicle 12. The powertrain of each electrified vehicle 12 may electrically propel the drive wheels 20 either with or without assistance from an internal combustion engine.

Although shown schematically, the traction battery pack 22 of each electrified vehicle 12 may be configured as a high voltage traction battery pack that includes a plurality of battery arrays (i.e., battery assemblies or groupings of battery cells) capable of outputting electrical power to the electric machine 18. Other types of energy storage devices and/or output devices may also be used to electrically power the electrified vehicle 12.

Each electrified vehicle 12 may further include a telecommunications module 24, a global positioning system (GPS) 26, a human machine interface (HMI) 28, and a control module 30. These and other components may be interconnected and in electronic communication with one another over a communication bus 32. The communication bus 32 may be a wired communication bus such as a controller area network (CAN) bus, or a wireless communication bus such as Wi-Fi, Bluetooth®, Ultra-Wide Band (UWB), etc.

Each telecommunications module 24 may be configured for achieving bidirectional communications with a cloud-based server system 34, for example. The telecommunications modules 24 may communicate over a cloud network 36 (e.g., the internet) to obtain various information stored on the server system 34 or to provide information to the server system 34. The server system 34 can identify, collect, and store user data associated with each electrified vehicle 12 for validation purposes. Upon an authorized request, data may be subsequently transmitted to each telecommunications module 24 via one or more cellular towers 38 or some other known communication technique (e.g., Wi-Fi, Bluetooth®, data connectivity, etc.). The telecommunications modules 24 can receive data from the server system 34 or can communicate data back to the server system 34 via the cellular tower(s) 38. Although not necessarily shown or described in this highly schematic embodiment, numerous other components may enable bidirectional communications between each electrified vehicle 12 of the vehicle fleet 14 and the server system 34.

In a first embodiment, an operator of each electrified vehicle 12 may interface with the server system 34 using the HMI 28. For example, the HMI 28 may be equipped with an application 40 (e.g., FordPass™ or another similar web-based application) for allowing users to interface with the server system 34. The HMI 28 may be located within a passenger cabin of the electrified vehicle 12 and may include various user interfaces for displaying information to the vehicle occupants and/or for allowing the vehicle occupants to enter information into the HMI 28. The vehicle occupants may interact with the user interfaces presentable on the HMI 28 via touch screens, tactile buttons, audible speech, speech synthesis, etc.

In another embodiment, the operator of each electrified vehicle 12 may alternatively or additionally interface with the server system 34 using a personal electronic device 42 (e.g., a smart phone, tablet, computer, wearable smart device, etc.). The personal electronic device 42 may include an application 44 (e.g., FordPass™ or another similar application) that includes programming to allow the user to employ one or more user interfaces 46 for interfacing with the server system 34, setting or controlling certain aspects of the system 10, etc. The application 44 may be stored in a memory 48 of the personal electronic device 42 and may be executed by a processor 50 of the personal electronic device 42. The personal electronic device 42 may additionally include a transceiver 52 that is configured to communicate with the server system 34 over the cellular tower(s) 38 or some other wireless link.

Each GPS 26 may be configured to pinpoint locational coordinates of its respective electrified vehicle 12. The GPS 26 may utilize geopositioning techniques or any other satellite navigation techniques for estimating the geographic position of the electrified vehicle 12 at any point in time.

Each control module 30 may include both hardware and software and could be part of an overall vehicle control system, such as a vehicle system controller (VSC), or could alternatively be a stand-alone controller separate from the VSC. In an embodiment, each control module 30 is programmed with executable instructions for interfacing with various components of the system 10. Although shown as separate modules within the highly schematic depiction of FIG. 1, the telecommunications module 24, the GPS 26, the HMI 28, and the control module 30 could be integrated together as part of common module within each of the electrified vehicles 12.

The server system 34 may include a control module 54 that is configured for coordinating and executing various control strategies and modes associated with the system 10. For example, the control module 54 may be programmed for performing various charge planning functions of the system 10. The control module 54 may include both a processor 56 and non-transitory memory 58. The processor 56 may be a custom made or commercially available processor, a central processing unit (CPU), a high performance computing (HPC) device, a clustering device, a quantum computing (QC) device, a quantum inspired optimization (QIO) device, or generally any device for executing software instructions. The memory 58 may include any one or combination of volatile memory elements and/or nonvolatile memory elements.

The processor 56 may be operably coupled to the memory 58 and may be configured to execute one or more programs (e.g., algorithms) stored in the memory 58 of the control module 54 based on various inputs, such as inputs received from each of the electrified vehicles 12 and inputs received from one or more servers associated with the server system 34. Information may be exchanged between the control module 54, the electrified vehicles 12, and the servers via one or more application programming interfaces, for example.

The control module 54 may receive inputs from one or more servers, including but not limited to a charging station server 64, for preparing the optimized charging path control strategy 16. The charging station server 64 may store data pertaining to each available charging station located within a given road network for charging the electrified vehicles 12 of the vehicle fleet 14. The charging stations stored on the charging station server 64 may include depot centers (e.g., charging stations owned/operated by the owner/proprietor of the system 10), public charging stations, and approved residential charging outlets (e.g., residential charging locations of fleet employees/friends). The charging location related data may include the location of each charging station, the type of charging offered at each charging station, the charging fee (e.g., kW cost) associated with charging at each charging location, etc.

The control module 54 may further receive inputs from each electrified vehicle 12 of the vehicle fleet 14 for preparing the optimized charging path control strategy 16. For example, the control module 54 may be programmed to leverage trip planner information 66 received from each electrified vehicle 12 for generating a road network that defines the relevant operational area for each electrified vehicle 12 of the vehicle fleet 14. The trip planner information 66 may include various information, including but not limited to identifying an origin, one or more destinations, and one or more waypoints that the electrified vehicle 12 will be required to travel to during an upcoming delivery/servicing trip. The trip planner information 66 may further include time constraint information, such as deliveries/service tasks that must be performed within a specific time window, for example.

The control module 54 may be further programmed to leverage vehicle information 68 received from each electrified vehicle 12 of the vehicle fleet 14 for preparing the optimized charging path control strategy 16. The vehicle information 68 may include but is not limited to information such as current vehicle location, current state of charge, current available range, battery health information, battery temperature information, vehicle type, vehicle weight, cargo type, cargo weight, etc.

The control module 54 may be further programmed to leverage driver information 70 associated with the driver of each electrified vehicle 12 of the vehicle fleet 14 for preparing the optimized charging path control strategy 16. The driver information 70 may include information such as the known driving habits/style/behavior of each driver, etc.

Based on the various inputs, the control module 54 may be programmed to associate a cost to a “time” (e.g., cost/minute) that will be necessary for performing each delivery/servicing task indicated by the trip planner information 66. The cost to time for each electrified vehicle 12 of the vehicle fleet 14 may be expressed using the following equation (1):

Cost_{time/houri}=#NUitemsᵢ*NUCostPerHourᵢ+#Uitemsᵢ*UCostPerHourᵢ
Where:
NUᵢₜₑₘₛ represents non-urgent delivery items; and
Uᵢₜₑₘₛ represents urgent delivery items.

The associated cost to time for a given delivery/servicing task could depend on factors such as urgency of the delivery, type of cargo (e.g., refrigerated goods or not), unavailability of the vehicle, overtime cost for the driver, time to travel to first delivery location after charging, etc. The actual cost assigned to each delivery/servicing task can vary depending on, among other things, the type of business being conducted by the vehicle fleet 14. For example, delivery of critical items (e.g., medicines, etc.) can be associated with a higher cost if not performed within a specific time window, and these deliveries can therefore be prioritized over deliveries of non-critical items as part of the optimized charging path control strategy 16.

A time-constrained delivery may be expressed by the following equation (2):

$${\sum }_{j = 1}^{\# {travelsegment}_{i}} {speed}_{{avg}_{ij}} * {miles}_{ij} \leq {MaxTime}_{i}$$

The control module 54 may be further programmed to associate a cost to vehicle “wear” (e.g., cost/mile). An associated cost for vehicle wear can be assigned to one or more consumable components of each electrified vehicle 12 (e.g., traction battery pack, electric machine, tires, influence on maintenance schedule, etc.). The associated cost to vehicle wear may depend on factors such as the costs associated with driving extra distances to alternative charging locations (including any necessary overtime that must be paid), the costs associated with fast charging and the resulting reduced longevity of the traction battery pack, etc. The cost to wear for each electrified vehicle 12 of the vehicle fleet 14 may be expressed using the following equation (3):

$${Cost}_{{wear}_{{vehicle}_{i}}} = {\sum }_{j = 1}^{\# {travelsegment}_{i}} {Wear}_{{cost}_{{permile}_{i}}} * {miles}_{ij}$$

The control module 54 may be further programmed to evaluate an available range (e.g., in miles or kilometers) of each electrified vehicle 12 of the vehicle fleet 14. The available range for each electrified vehicle 12 may be estimated based on the vehicle information 68 and the driver information 70 and could be a function of factors such as the type of vehicle, the type, weight, and location of the cargo being hauled by the vehicle, the driver's driving behavior, the urgency of the delivery, etc. Constraints associated with a maximum range (given a starting battery charge) may be expressed using the following equation (4)

$${\sum }_{k = 1}^{\# tonextcharge} {miles}_{ik} \leq {Range ( charge )}_{i}$$

The control module 54 may be further programmed to solve the charging path optimization problem for each electrified vehicle 12 within the cost and constraint structure of the entire vehicle fleet 14. In an embodiment, the control module 54 may employ one or more optimization algorithms for solving the charging path optimization problem. An exemplary optimization algorithm may be represented by the following equations (5), (6), and (7):

$$ObjectiveFunction + {Cost}_{time \& wear \& {driver}_{vehicle}} + {Cost}_{{charging}_{{vehicle}_{i}}} + {Cost}_{{overnight}_{i}} \qquad Equation 5$$

$${\sum }_{j = 1}^{\# {travelsegment}_{i}} {speed}_{{avg}_{ij}} * {miles}_{ij} \leq {MaxTime}_{i} \qquad Equation 6$$

$${\sum }_{k = 1}^{\# tonextcharge} {miles}_{ik} \leq {Range ( charge )}_{i} \qquad Equation 7$$

Based on the outputs of one or more of the above equations, the control module 54 may generate the optimized charging path control strategy 16. The optimized charging path control strategy 16 may include instructions for when, where, and how long to charge each electrified vehicle 12 of the vehicle fleet 14 and the travel path each electrified vehicle 12 should take. The instructions may be presented on the HMI 28 and/or the personal electronic device 42 associated with each electrified vehicle 12, for example.

As alluded to above, the control module 54 may consider residential charging outlets when choosing the optimal charging path for one or more of the electrified vehicles. For example, the optimized charging path control strategy 16 may provide for charging certain vehicles of the vehicle fleet 14 at the home residence of the driver of the particular vehicle. This decision may include considering factors such as the cost to charge associated with charging at different times of the day, geographic location, electric company, residential contract, etc. The residential owner may be offered additional compensation depending on location, time of day, and criticality of service, which could also be factored in when determining the best charging path for a given vehicle. The cost to charge may be expressed using the following equation (8):

$${Cost}_{{charging}_{{vehicle}_{i}}} = {\sum }_{j = 1}^{\# {charges}_{i}} {KW}_{ij} * {KW}_{{price}_{ij}} + {\sum }_{j = 1}^{\# {charges}_{i}} {KW}_{ij} * {chargetime}_{{perKW}_{ij}} * {Cost}_{{time}_{{perhour}_{i}}}$$

When a residential charging decision is included within the optimal charging path control strategy 16, the driver/residential owner may be notified, with the time and the amount of charge requested, and monetary compensation may be offered. If the driver/residential owner commits to the request, he/she may affirmatively respond or otherwise reject the offer. If rejected, the system 10 may re-optimize the charging path for all affected vehicles of the vehicle fleet 14.

In the case of a positive transaction, the vehicle may be “unlocked” to charge at the specific residential geolocation for the specified charge time and amount. When the transaction is completed, the driver/residential owner may again be notified, and the monetary transaction may then be processed.

The optimized charging path control strategy 16 may further include instructions for “locking” any charging outlet that is not designated by the manager of the system 10. Exceptions may be made upon request by a driver and for circumstances that could potentially reduce the available vehicle range, such as when a designated charging outlet is not functional for any reason or when longer than expected charging delays occur.

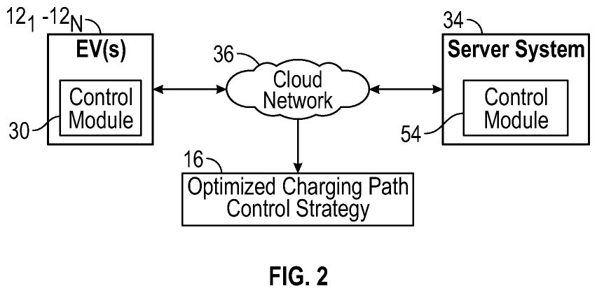

In the embodiments described above, the control module 54 of the server system 34 is configured to function as the communications hub of the system 10. However, other embodiments are also contemplated within the scope of this disclosure. For example, as schematically shown in FIG. 2, the control modules 30 of each electrified vehicle 12 of the vehicle fleet 14 and the control module 54 of the server system 34 may operate together over the cloud network 36 to establish an optimized charging path control system for preparing the optimized charging path control strategy 16. In still other embodiments, the optimized charging path control strategy 16 could implemented on an individual vehicle basis (e.g., within the control module 30 of an electrified vehicle 12) to provide optimized charging path solutions to individual, non-fleet customers.

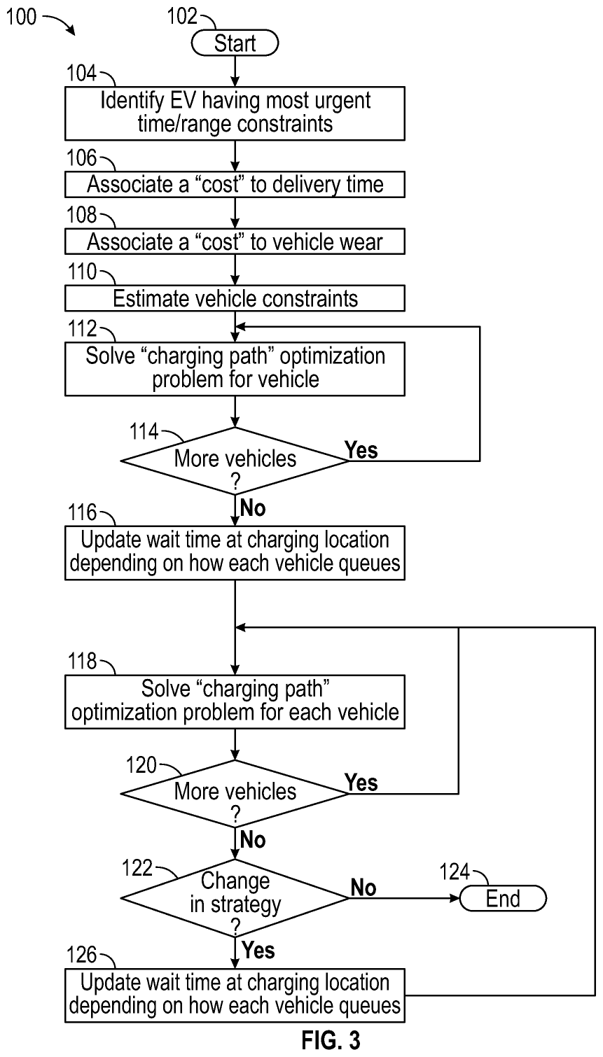

FIG. 3, with continued reference to FIGS. 1-2, schematically illustrates in flow chart form an exemplary method 100 for coordinating and executing the optimized charging path control strategy 16 of the system 10. Per the method 100, the optimized charging path control strategy 16 may be created to iteratively provide charging path instructions for each electrified vehicle 12 of the vehicle fleet 14 in a manner that balances time, vehicle component wear, and cost for electricity, for example.

The system 10 may be configured to employ one or more algorithms adapted to execute at least a portion of the steps of the exemplary method 100. For example, the method 100 may be stored as executable instructions in the memory 58 of the control module 54, and the executable instructions may be embodied within any computer readable medium that can be executed by the processor 56 of the control module 54. The method 100 could alternatively or additionally be stored as executable instructions in the memories of the control modules 30 of one or more of the electrified vehicles 12.

The exemplary method 100 may begin at block 102. At block 104, the method 100 may identify a first electrified vehicle 12₁ of the vehicle fleet 14 that has the most urgent time and/or range constraints. The optimal charging path for the electrified vehicle 12₁ having the most urgent time and/or range constraints may be considered first within the method 100.

Next, at block 106, the method 100 may assign a cost to delivery time required for performing each delivery/servicing task indicated by the trip planner information 66 associated with the electrified vehicle 12₁. A cost to vehicle component wear may then be assigned at block 108.

The method 100 may next estimate any constraints of the electrified vehicle 12₁ at block 110. The constraints may include the available range of the electrified vehicle 12₁ and maximum time windows for performing each delivery/servicing task indicated by the trip planner information 66. Other constraints may alternatively or additionally be considered as part of this step.

The method 100 may solve the charging path optimization problem for the electrified vehicle 12₁ at block 112. Solving the charging path optimization problem may include preparing instructions for most optimally charging the electrified vehicle 12₁ during its scheduled operation (e.g., by preparing the optimized charging path control strategy 16). Solving the charging path optimization problem may further involve utilizing one or more of the optimization algorithms noted herein.

At block 114, the method 100 may identify whether there are additional electrified vehicles 12 of the vehicle fleet 14 that should be considered as part of the charging path optimization analysis. If YES, the method 100 may return to block 112 and the charging path for a second electrified vehicle 12₂ may be accounted for while also adjusting the charging path of the electrified vehicle 12₁ to the extent necessary. This iterative process may continue for each additional electrified vehicle 12 of the vehicle fleet 14 in order to optimize the charging path for the entire vehicle fleet 14.

Once a NO flag is returned at block 114, thus indicating that all electrified vehicles 12 of the vehicle fleet 14 have been accounted for, the method 100 may proceed to block 116. At this step, the method 100 may update the wait time expected at each charging location depending on how each electrified vehicle 12 queues at its respective charging location. The charging path optimization problem may then be re-solved at block 118 in order to account for any adjusted wait times.

The method 100 may again identify whether there are additional electrified vehicles 12 of the vehicle fleet 14 that should be considered as part of the charging path analysis at block 120. If YES, the method 100 may return to block 118 and the charging path optimization problem may be re-solved. If NO, the method 100 may confirm whether there has been a change in the charging path strategy at bock 122.

If a NO flag is returned at block 122, the method 100 may end at block 124. Alternatively, if a YES flag is returned at block 122, the method 100 may proceed to block 126 by updating the wait time at each charging location depending on how each electrified vehicle 12 queues at its respective charging location. The method 100 may then once again return to block 118 as part of providing an iterative, open loop process for preparing the optimized charging path control strategy 16.

The electrified vehicle fleet management systems of this disclosure are designed to provide optimized charging paths for each vehicle of the fleet during planned trips. The proposed systems and methods provide for a multi-objective (e.g., time, wear, and charging costs) optimization of vehicle charging.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A fleet management system, comprising:
a plurality of electrified vehicles; and
a control module programmed to create an optimized charging path control strategy that includes instructions for charging each of the plurality of electrified vehicles prior to, during, or after a delivery/servicing task,
wherein the instructions are derived based on a multi-objective charging cost goal.

2. The system as recited in claim 1, wherein the multi-objective charging cost goal is based on a cost associated with a delivery time, a cost associated with a vehicle component wear, and a cost associated with charging.

3. The system as recited in claim 1, wherein the control module is further programmed to modify the instructions according to a revised wait time at an assigned charging location.

4. The system as recited in claim 1, wherein the control module is a component of at least one of the plurality of electrified vehicles.

5. The system as recited in claim 1, wherein the control module is a component of a cloud-based server system.

6. The system as recited in claim 5, wherein the cloud-based server system is operably connected to a charging station server, and further wherein the multi-objective charging cost goal is derived using information from the charging station server.

7. The system as recited in claim 6, wherein the multi-objective charging cost goal is further derived using vehicle information and driver information associated with each of the plurality of electrified vehicles.

8. The system as recited in claim 7, wherein the multi-objective charging cost goal is further derived using trip planner information associated with each of the plurality of electrified vehicles.

9. The system as recited in claim 1, wherein the optimized charging path control strategy includes instructions for charging at least one of the plurality of electrified vehicles a residential charging location.

10. The system as recited in claim 1, wherein the control module is programmed to execute an optimization algorithm for preparing the optimized charging path control strategy.

11. An electrified vehicle, comprising:
a traction battery pack; and
a control module programmed to receive an optimized charging path control strategy that includes instructions for charging the traction battery pack prior to, during, or after an assigned delivery/servicing task,
wherein the instructions are derived based on a multi-objective charging cost goal.

12. The electrified vehicle as recited in claim 11, wherein the multi-objective charging cost goal is based on a cost associated with a delivery time, a cost associated with a vehicle component wear, and a cost associated with recharging the traction battery pack.

13. The electrified vehicle as recited in claim 11, wherein the multi-objective charging cost goal is derived using information from a charging station server.

14. The electrified vehicle as recited in claim 13, wherein the multi-objective charging cost goal is further derived using vehicle information and driver information associated with the electrified vehicle.

15. The electrified vehicle as recited in claim 14, wherein the multi-objective charging cost goal is further derived using trip planner information associated with the electrified vehicle.

16. The electrified vehicle as recited in claim 11, wherein the optimized charging path control strategy includes instructions for charging the traction battery pack at a residential charging location.

17. The electrified vehicle as recited in claim 11, wherein the optimized charging path control strategy is received from a cloud-based server system.

18. The electrified vehicle as recited in claim 11, wherein the electrified vehicle is part of a vehicle fleet.

19. The electrified vehicle as recited in claim 11, wherein the electrified vehicle is a plug-in type electrified vehicle.

20. A charge planning method, comprising:
assigning a cost to time for performing a delivery/servicing task for each electrified vehicle of a vehicle fleet;
assigning a cost to vehicle component wear for performing the delivery/service task for each electrified vehicle of the vehicle fleet;
estimating a range constraint for each electrified vehicle of the vehicle fleet; and
generating an optimized charging path control strategy for charging each electrified vehicle of the vehicle fleet,
wherein the optimized charging path control strategy is derived at least from assigning the cost to time, assigning the cost to vehicle component wear, and estimating the range constraint.
